(19) United States
(12) Patent Application Publication
(10) Pub. No.: US 2019/0057344 A1
(43) Pub. Date: Feb. 21, 2019

(54) VISIBLE FOOD PRODUCT STATUS INDICATION

(71) Applicant: Tayor Commercial Foodservice Inc., Rockton, IL (US)

(72) Inventor: James J. Minard, Roscoe, IL (US)

(73) Assignee: Taylor Commercial Foodservice Inc., Rockton, IL (US)

(21) Appl. No.: 16/101,058

(22) Filed: Aug. 10, 2018

Related U.S. Application Data
(60) Provisional application No. 62/548,015, filed on Aug. 21, 2017.

(51) Int. Cl. G06Q 10/08; G06Q 20/20; G06Q 10/06

(52) U.S. Cl. CPC G06Q 10/087; G06Q 50/12; G06Q 10/067; G06Q 20/20

(57) ABSTRACT

A system for providing a visible indication of food product status. The system includes a camera configured to image a holding area containing a food product; a controller configured to initiate a product timer for the food product in the holding area; and a projection system to project a visible, food status indicia proximate to the food product in response to the product timer.

### RELATED APPLICATION

The present patent document claims the benefit of the filing date under 35 U.S.C. § 119(e) of Provisional U.S. Patent Application Ser. No. 62/548,015, filed Aug. 21, 2017, which is hereby incorporated by reference.

### BACKGROUND

The subject matter disclosed herein generally relates to indicating a status of a food product, and in particular to generating a visual food product status indication.

Food products are often cooked and then held in a holding area prior to being served to a consumer. The food product may be routed through the holding area using a first-in/first-out manner. If the food product remains in the holding area for too long, then it must be removed so that it is not served in its current state. Conventionally, a timer is used to determine how long a food product has been in the holding area. This can lead to errors in setting one or more timers and determining which food products correspond to which timer.

### SUMMARY

According to an embodiment, a system for providing a visible indication of food product status includes a camera configured to image a holding area containing a food product; a controller configured to initiate a product timer for the food product in the holding area; and a projection system to project a visible, food status indicia proximate to the food product in response to the product timer.

In addition to one or more of the features described herein, or as an alternative, further embodiments may include wherein the food product is associated with a time limit.

In addition to one or more of the features described herein, or as an alternative, further embodiments may include wherein the projection system projects a food status indicia proximate to the food product in response to the product timer exceeding the time limit.

In addition to one or more of the features described herein, or as an alternative, further embodiments may include wherein the projection system projects a food status indicia proximate to the food product in response to the product timer exceeding a predetermined percentage of the time limit.

In addition to one or more of the features described herein, or as an alternative, further embodiments may include wherein the projection system projects a food status indicia proximate to the food product in response to the product timer having the greatest value of a plurality of product timers for food products of the same type in the holding area.

In addition to one or more of the features described herein, or as an alternative, further embodiments may include wherein the controller detects removal of the food product from the holding area using image processing.

In addition to one or more of the features described herein, or as an alternative, further embodiments may include wherein the controller detects addition of the food product to the holding area using image processing.

In addition to one or more of the features described herein, or as an alternative, further embodiments may include wherein the projection system projects a first food status indicia proximate to the food product in response to the product timer exceeding the hold time limit; wherein the projection system projects a second food status indicia proximate to the food product in response to the product timer exceeding a predetermined percentage of the hold time limit; wherein the first food status indicia has a first color and the second food status indicia has a second color, the first color different than the second color.

In addition to one or more of the features described herein, or as an alternative, further embodiments may include wherein the product timer varies based on the food product type.

According to another embodiment, a method for providing a visible indication of food product status includes obtaining an image of a holding area containing a food product; initiating a product timer for the food product in the holding area; and projecting a visible, food status indicia proximate to the food product in response to the product timer.

In addition to one or more of the features described herein, or as an alternative, further embodiments may include wherein the food product is associated with a time limit.

In addition to one or more of the features described herein, or as an alternative, further embodiments may include wherein the projecting comprises projecting a food status indicia proximate to the food product in response to the product timer exceeding the time limit.

In addition to one or more of the features described herein, or as an alternative, further embodiments may include wherein the projecting comprises projecting a food status indicia proximate to the food product in response to the product timer exceeding a predetermined percentage of the time limit.

In addition to one or more of the features described herein, or as an alternative, further embodiments may include wherein the projecting comprises projecting a food status indicia proximate to the food product in response to the product timer having the greatest value of a plurality of product timers for food products of the same type in the holding area.

In addition to one or more of the features described herein, or as an alternative, further embodiments may include further comprising detecting removal of the food product from the holding area using image processing.

In addition to one or more of the features described herein, or as an alternative, further embodiments may include further comprising detecting addition of the food product to the holding area using image processing.

In addition to one or more of the features described herein, or as an alternative, further embodiments may include wherein the projecting comprises projecting a first food status indicia proximate to the food product in response to the product hold timer exceeding the hold time limit; wherein the projecting comprises projecting a second food status indicia proximate to the food product in response to the product hold timer exceeding a predetermined percentage of the hold time limit; wherein the first food status indicia has a first color and the second food status indicia has a second color, the first color different than the second color.

In addition to one or more of the features described herein, or as an alternative, further embodiments may include wherein the product timer varies based on the food product type.

According to another embodiment, a computer program product, is tangibly embodied on a computer readable medium, for providing a visible indication of food product status, the computer program product including instructions that, when executed by a processor, cause the processor to initiate operations including obtaining an image of a holding area containing a food product; initiating a product timer for the food product in the holding area; and projecting a visible, food status indicia proximate to the food product in response to the product timer.

Technical effects of embodiments include projection of a visible food status indicia proximate to a food product in a holding area. The visible food status indicia indicates how long the food product has been in the holding area and whether the food product has been in the holding area for a time greater than a time limit.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 depicts a system for generating a visible food status indicia in an example embodiment;

FIG. 2 depicts a method for detecting a food product in a holding area in an example embodiment;

FIG. 3 depicts a holding area in an example embodiment;

FIG. 4 depicts a holding area in an example embodiment;

FIG. 5 depicts food product records in an example embodiment;

FIG. 6 depicts a process for projecting a visible food status indicia proximate to food products in the holding area in an example embodiment; and

FIG. 7 depicts food status indicia projected proximate to food products in the holding area in an example embodiment.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

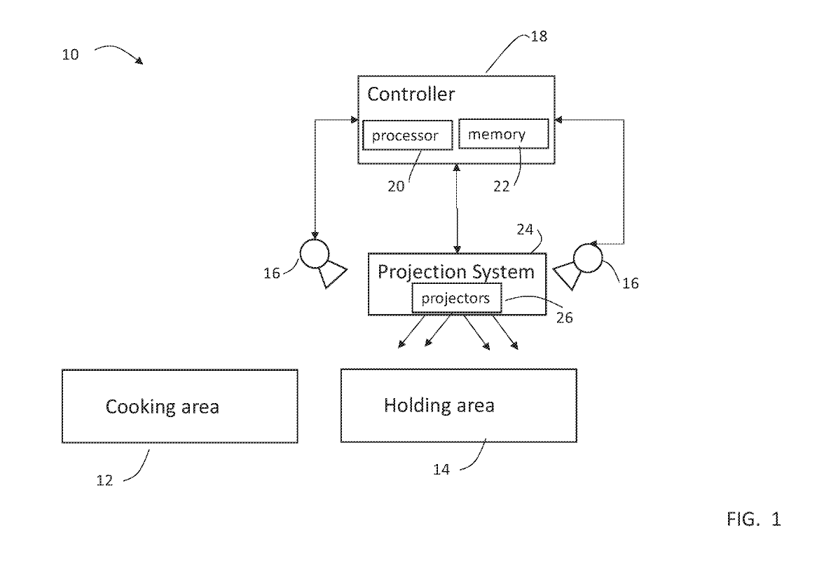

FIG. 1 depicts a system 10 for generating visible food status indicia in an example embodiment. System 10 includes a cooking area 12 and a holding area 14. The cooking area 12 may include a grill, griddle, fryer, etc. Once a food product is cooked, it is moved to the holding area 14 where it is held until served to a consumer. As noted above, food products should only remain in the holding area 14 for a certain period of time, referred to herein as a time limit.

One or more cameras 16 are positioned to acquire images of the holding area 14. The camera 16 may operate on a variety of light spectrums, such as visible light, infrared, etc. The images from camera 16 are provided to a controller 18. The controller 18 may include a processor 20 and memory 22. The processor 20 can be any type or combination of computer processors, such as a microprocessor, microcontroller, digital signal processor, application specific integrated circuit, programmable logic device, and/or field programmable gate array. The memory 22 is an example of a non-transitory computer readable storage medium tangibly embodied in the controller 18 including executable instructions stored therein, for instance, as firmware. The processor 20 executes the instructions in memory 22 to implement the operations described herein.

A projection system 24 is coupled to the controller 18 and is used to project visible food status indicia proximate to one or more food products in the holding area 14. The phrase “proximate to” is intended to include indicia projected onto the food product and indicia projected near the food product. The visible food status indicia are used to indicate if a food product in the holding area 14 is approaching its time limit or if a food product in the holding area 14 has exceeded its time limit. Another visible indicia may be used to indicate the food product that has been in the holding area the longest, but has not reached a predetermined percentage of its time limit. Another visible indicia may be used to indicate the food product is the preferred food product (among those in the holding area 14) for use on a sandwich or other assembled food item. The visible food status indicia may include any type of indicator, such as alphanumeric indicia, colored indicia, graphical symbols, and combinations thereof.

The projection system 24 includes one more projectors 26 used to project visible food status indicia proximate to food products in the holding area 14. The projectors 26 may use laser projection to project visible food status indicia proximate to food products in the holding area 14. Other projection techniques may be used and embodiments are not limited to laser projection.

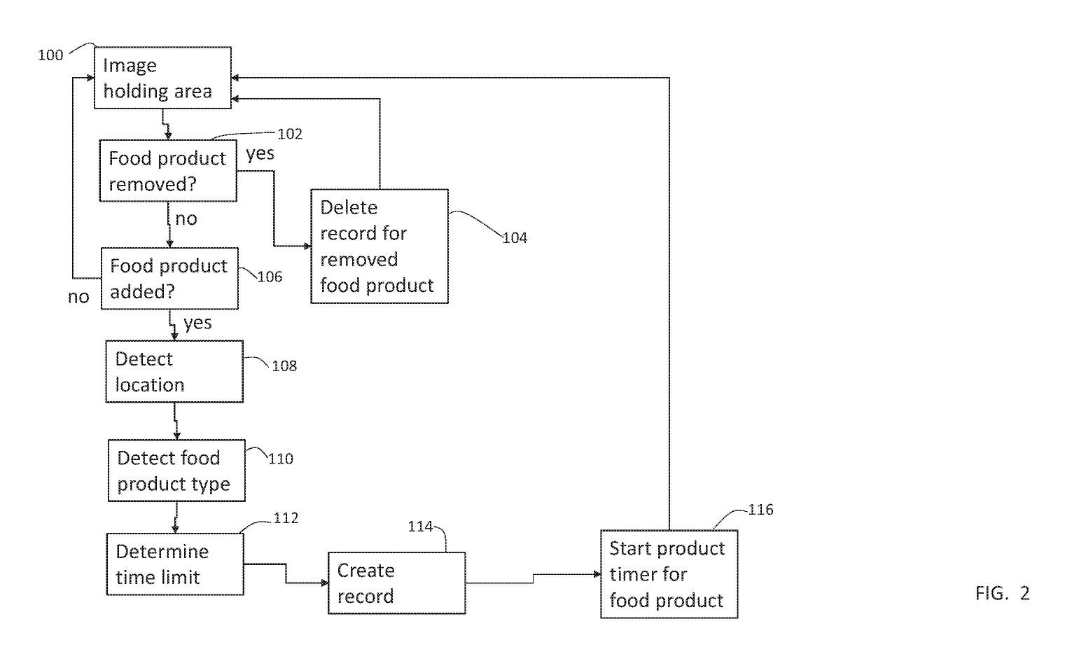

FIG. 2 depicts a method for detecting food products in a holding area 14 in an example embodiment. In order to project a visible food status indicia proximate to a food product in the holding area 14, the controller 18 first detects food products in the holding area 14 and determines the type of food products in the holding area 14, which can be done by evaluating the size, color, shape, or other characteristic of the food product. The process begins at 100, which the holding area 14 is imaged by camera 16. The imaging may occur in real time or frequently (e.g., once every second, or two seconds, or fraction of a second) to detect the current state of the holding area 14.

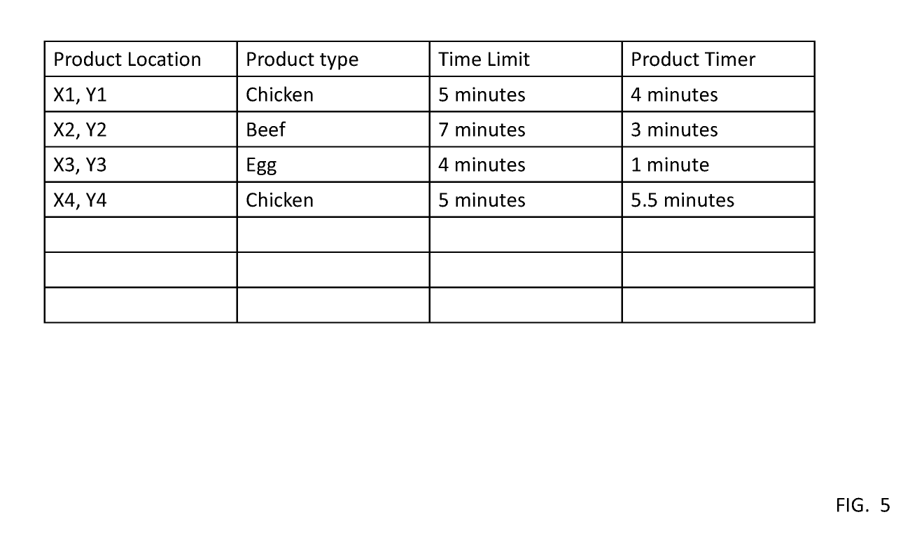

At 102, the controller determines if a food product has been removed from the holding area 14. Controller 18 may execute step 102 using image processing, such as comparing successive images of the holding area 14. The holding area 14 may have a distinctive color background (e.g., blue) such that food products can be detected by analyzing pixel colors in the images from camera 16. If a region changes from a non-background color to the background color, this indicates a food product has been removed. The controller 18 compares successive images to determine if a food product has been removed. Mathematical operations may be used, such as, a current image being subtracted from a prior image. Any large areas of difference can then be analyzed to determine if a food product has been removed from the holding area. If a food product is removed at 102, then flow proceeds to 104 where the record (discussed below with reference to FIG. 5) associated with that food product is deleted from memory 22.

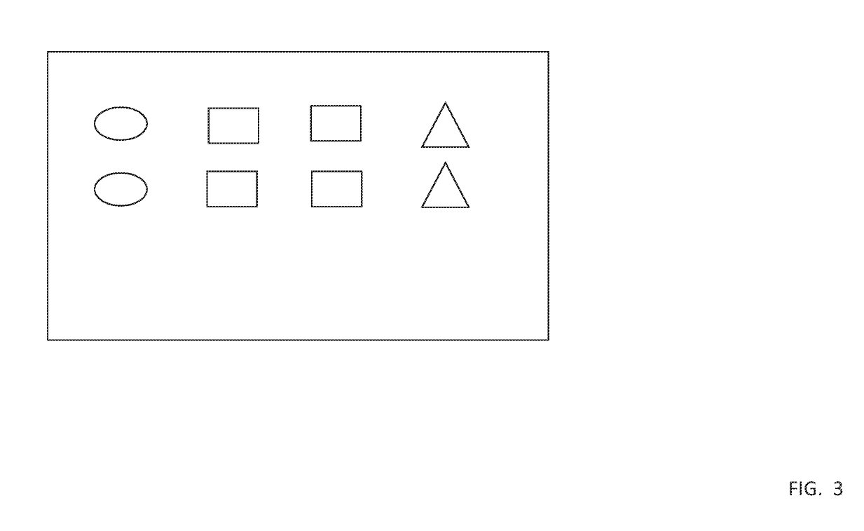

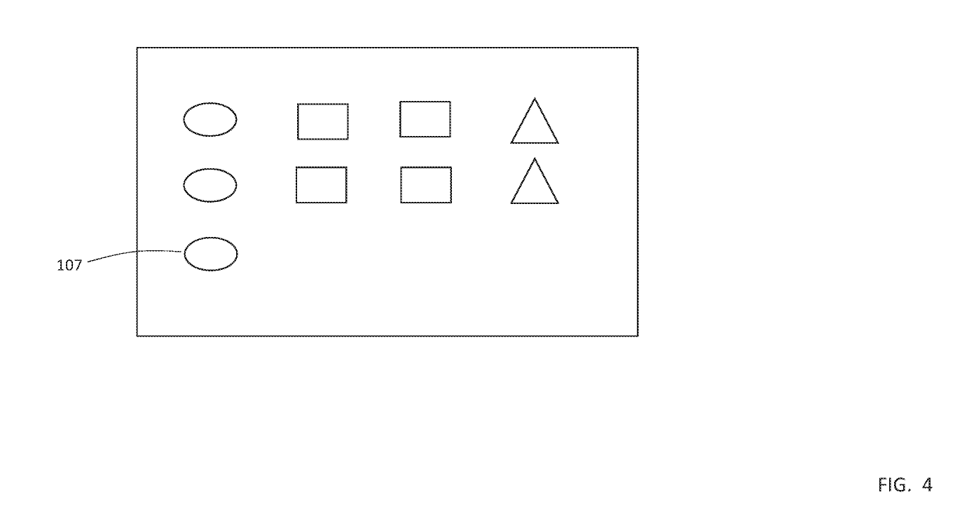

If a food product is not removed from the holding area at 104, flow proceeds to 106 where the controller 18 determines if a food product has been added to the holding area 14. FIGS. 3 and 4 illustrate how detection of a new food product in the holding area 14 occurs in an embodiment. FIG. 3 depicts an image of the holding area 14, including a number of food products of varying types (e.g., chicken breasts, hamburgers, egg patties). The next image acquired by camera 16, shown in FIG. 4, indicates that a new food product 107 has been added to the holding area 14. Detection of the new food product may be performed using image processing, such as comparing successive images of the holding area 14. For example, if a region changes from the background color (e.g., blue) to a non-background color, this indicates a food product has been added. Mathematical operations may be used, such as, a current image being subtracted from a prior image. Any large areas of difference can then be analyzed to determine if a food product has been added to the holding area 14. If a food product is not added at 106, then flow returns to 100.

If a food product has been added at 106, flow proceeds to blocks 108 to 114, where a record for the food product is created and stored in memory 22. Sample records are shown in FIG. 5. For each food product in the holding area 14, the controller 18 creates a record including its location, food product type, time limit and product timer. At 108, the location may be determined using x, y coordinates in the image acquired by camera 16. The controller 18 may use a centroid of the pixels corresponding of the food product as the x, y location. At 110, the type of food product may be determined by controller 18 using color and/or shape analysis. For example, hamburger patties may be brown and square whereas chicken breasts may be off-white and oblong. The controller 18 uses color and/or shape to detect the food product type.

At 112, the time limit is determined based on the food product type. For example, a chicken breast may have a time limit of 5 minutes whereas a hamburger may have a time limit of 7 minutes. These time limits are programmed into controller 18 by an installer or operator of the system 10, and may be adjusted. The time limit indicates how long a food product can stay in the holding area 14 until it must be removed and either discarded or used in some other form (e.g., repurposed). At 114, a record is created as shown in FIG. 5 for the food product. At 116, a product timer is started for the food product. The product timer indicates the current amount of time that the food product has been in the holding area 14. The controller 18 begins the product timer when the food product is detected in the holding area 14.

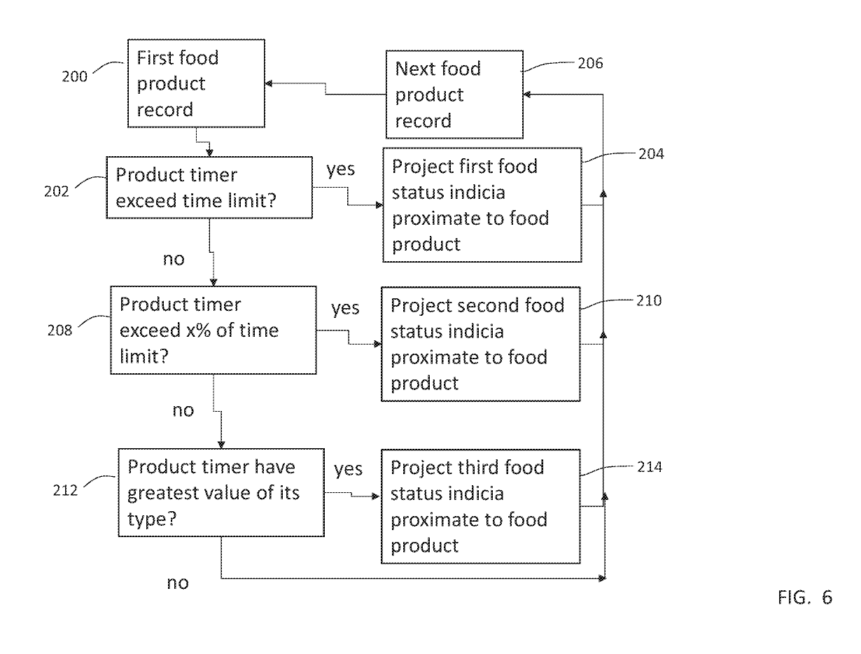

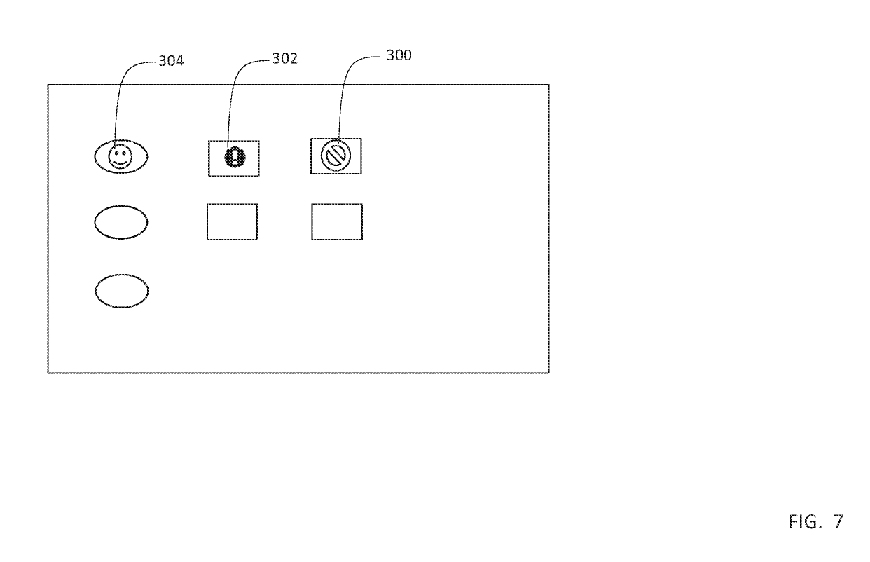

FIG. 6 depicts a process for projecting food status indicia proximate to food products in the holding area 14 in an example embodiment. The process begins at 200 where controller 18 examines a record for a first food product in holding area 14. At 202, the controller 18 determines if the product timer for this food product exceeds its respective time limit. As noted above, different types of food products may have different time limits. If at 202, the product timer exceeds its respective time limit, flow proceeds to 204 where the controller 18 instructs the projection system 24 to project a first food status indicia proximate to the corresponding food product. FIG. 7 depicts the holding area 14 where a first food status indicia 300 has been projected proximate to a food product. This first food status indicia 300 indicates that this food product should be removed from the holding area 14 and discarded or repurposed. In the example in FIG. 7, the first food status indicia 300 is a prohibited symbol, but the first food status indicia 300 may be a color (e.g., red), an alphanumeric symbol, or a combination of indicia and color. From 204, flow proceeds to 206 where the next food product record is examined.

If at 202, the product timer does not exceed its respective time limit, flow proceeds to 208. At 208, the controller 18 determines if the product timer for this food product exceeds a predetermined percentage of its respective time limit. For example, the predetermined percentage may be 80%. The predetermined percentage may be programmed into controller 18 by an installer or operator of the system 10, and may be adjusted.

If at 208, the product timer exceeds a predetermined percentage of its respective time limit, flow proceeds to 210 where the controller 18 instructs the projection system 24 to project a second food status indicia proximate to the corresponding food product. FIG. 7 depicts the holding area 14 where a second food status indicia 302 has been projected proximate to a food product. This second food status indicia 302 indicates that this food product is getting close to its time limit and should be selected next for serving. In the example in FIG. 7, the second food status indicia 302 is an exclamation point, but the second food status indicia 302 may be a color (e.g., yellow), an alphanumeric symbol, or a combination of indicia/color. From 210, flow proceeds to 206 where the next food product record is examined.

If at 208, the product timer does not exceed the predetermined percentage of its respective time limit, flow proceeds to 212. At 212, the controller 18 determines if the product timer for the food product has greatest value of a plurality of product timers for food products of the same type in the holding area 14. For example, the controller 18 determines whether a hamburger has been in the holding area 14 the longest of all the hamburgers in the holding area 14. If so, flow proceeds to 214 where the controller 18 instructs the projection system 24 to project a third food status indicia proximate to the corresponding food product. FIG. 7 depicts the holding area 14 where a third food status indicia 304 has been projected proximate to a food product. This third food status indicia 304 indicates that this food product should be selected next for serving (e.g., first-in/first-out queue). In the example in FIG. 7, the third food status indicia 304 is a smiley face, but the third food status indicia 304 may be a color (e.g., green), an alphanumeric symbol, or a combination of indicia/color. From 214, flow proceeds to 206 where the next food product record is examined. If all the food products have been considered, then the process returns to the first food product record.

Those of skill in the art will appreciate that various example embodiments are shown and described herein, each having certain features in the particular embodiments, but the present disclosure is not thus limited. That is, features of the various embodiments can be exchanged, altered, or otherwise combined in different combinations without departing from the scope of the present disclosure.

Embodiments may be implemented as one or more apparatuses, systems, and/or methods. In some embodiments, instructions may be stored on one or more computer program products or computer-readable media, such as a transitory and/or non-transitory computer-readable medium. The instructions, when executed, may cause an entity (e.g., a processor, apparatus or system) to perform one or more operations as described herein.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. A system for providing a visible indication of food product status, the system comprising:
a camera configured to image a holding area containing a food product;
a controller configured to initiate a product timer for the food product in the holding area; and
a projection system to project a visible, food status indicia proximate to the food product in response to the product timer.

2. The system of claim 1 wherein the food product is associated with a time limit.

3. The system of claim 2 wherein the projection system projects a food status indicia proximate to the food product in response to the product timer exceeding the time limit.

4. The system of claim 2 wherein the projection system projects a food status indicia proximate to the food product in response to the product timer exceeding a predetermined percentage of the time limit.

5. The system of claim 2 wherein the projection system projects a food status indicia proximate to the food product in response to the product timer having the greatest value of a plurality of product timers for food products of the same type in the holding area.

6. The system of claim 1 wherein the controller detects removal of the food product from the holding area using image processing.

7. The system of claim 1 wherein the controller detects addition of the food product to the holding area using image processing.

8. The system of claim 2 wherein the projection system projects a first food status indicia proximate to the food product in response to the product timer exceeding the hold time limit;
wherein the projection system projects a second food status indicia proximate to the food product in response to the product timer exceeding a predetermined percentage of the hold time limit;
wherein the first food status indicia has a first color and the second food status indicia has a second color, the first color different than the second color.

9. The system of claim 1, wherein the product timer varies based on the food product type.

10. A method for providing a visible indication of food product status, the method comprising:
obtaining an image of a holding area containing a food product;
initiating a product timer for the food product in the holding area; and
projecting a visible, food status indicia proximate to the food product in response to the product timer.

11. The method of claim 10 wherein the food product is associated with a time limit.

12. The method of claim 11 wherein the projecting comprises projecting a food status indicia proximate to the food product in response to the product timer exceeding the time limit.

13. The method of claim 11 wherein the projecting comprises projecting a food status indicia proximate to the food product in response to the product timer exceeding a predetermined percentage of the time limit.

14. The method of claim 11 wherein the projecting comprises projecting a food status indicia proximate to the food product in response to the product timer having the greatest value of a plurality of product timers for food products of the same type in the holding area.

15. The method of claim 10 further comprising detecting removal of the food product from the holding area using image processing.

16. The method of claim 9 further comprising detecting addition of the food product to the holding area using image processing.

17. The method of claim 11 wherein the projecting comprises projecting a first food status indicia proximate to the food product in response to the product hold timer exceeding the hold time limit;
wherein the projecting comprises projecting a second food status indicia proximate to the food product in response to the product hold timer exceeding a predetermined percentage of the hold time limit;
wherein the first food status indicia has a first color and the second food status indicia has a second color, the first color different than the second color.

18. The method of claim 10, wherein the product timer varies based on the food product type.

19. A computer program product, tangibly embodied on a computer readable medium, for providing a visible indication of food product status, the computer program product including instructions that, when executed by a processor, cause the processor to initiate operations comprising:
obtaining an image of a holding area containing a food product;
initiating a product timer for the food product in the holding area; and
projecting a visible, food status indicia proximate to the food product in response to the product timer.
